(19) United States
(12) Patent Application Publication
(10) Pub. No.: US 2026/0042962 A1
(43) Pub. Date: Feb. 12, 2026

(54) Single-Mode Excitation Color-Changing Luminescent Upconversion Material and Preparation Method Thereof

(71) Applicant: Suzhou University of Science and Technology, Suzhou City (CN)

(72) Inventors: Chunxian Guo, Suzhou City (CN); Yanqing Hu, Suzhou City (CN)

(21) Appl. No.: 19/251,629

(22) Filed: Jun. 26, 2025

Related U.S. Application Data
(63) Continuation of application No. PCT/CN2025/095732, filed on May 19, 2025.

(30) Foreign Application Priority Data
Aug. 8, 2024 (CN) 2024110865872

(51) Int. Cl. C09K 11/77; C01F 17/30

(52) U.S. Cl. CPC C09K 11/7773; C01F 17/30; C01P 2002/52; C01P 2002/72; C01P 2006/60

(57) ABSTRACT

A single-mode excitation color-changing luminescent upconversion material, and its preparation method are provided. The molecular formula of the single-mode excitation color-changing luminescent upconversion material is AₓMOCl_{y-1}:Yb/Ln, where A is at least one of Lithium(I) ion (Li⁺), Sodium(I) ion (Na⁺), Sodium(I) ion (K⁺), or Cesium(I) ion (Cs⁺); M is at least one of Lanthanum(III) ion (La³⁺), Yttrium(III) ion (Y³⁺), Gadolinium(III) ion (Gd³⁺), or Lutetium(III) ion (Lu³⁺); Ln is at least one of Erbium(III) ion (Er³⁺), Holmium(III) ion (Ho³⁺), or Holmium(III) ion (Tm³⁺), with 1≤x≤4 and 4≤y≤7. The excitation wavelength range of the material is 950 nanometers (nm)-1100 nm, and the emission wavelength range is 400 nm-800 nm. Under single-mode near-infrared excitation, the material exhibits color-changing upconversion luminescence.

### CROSS-REFERENCE TO RELATED APPLICATIONS

This application is a continuation of PCT/CN2025/095732, filed on May 19, 2025 and claims priority to Chinese Patent Application No. 202411086587.2, filed on Aug. 8, 2024 the contents of which are hereby incorporated by reference.

### TECHNICAL FIELD

The present disclosure relates to the field of optical anti-counterfeiting technology, and particularly to a single-mode excitation color-changing luminescent upconversion material and a preparation method thereof.

### BACKGROUND

Globally, counterfeit goods cause economic losses exceeding 1.7 trillion dollars annually. Counterfeiting in pharmaceuticals, high-value goods, and currency severely threatens the health of consumers, the interests of enterprises, and economic security. Anti-counterfeiting strategies may make genuine products difficult to replicate and effectively prevent counterfeit goods from circulating in the market. Rare-earth-doped upconversion crystal materials, as one of the anti-counterfeiting strategies, offer advantages such as low background fluorescence and strong resistance to photobleaching. Currently, upconversion materials used in currency and high-value goods exhibit single green emission. Under near-infrared excitation, the emission color of these materials remains almost unchanged. Anti-counterfeiting patterns constructed with such materials may still be imitated by counterfeiters using other materials with similar luminescence.

The security level of upconversion anti-counterfeiting materials may be improved by controlling luminescence colors. In recent years, extensive research has been conducted on multicolor fluorescent materials. For example, multicolor fluorescence may be generated through multimode fluorescence, laser power adjustment, or pulsed lasers. These strategies significantly enhance the security level of anti-counterfeiting technology. However, relatively complex identification equipment is required to trigger the multicolor luminescence of these new upconversion materials. First, upconversion and downconversion synergistic luminescence require multiple excitation sources; second, power-dependent multicolor luminescence requires adjustable ultra-high-power lasers; finally, tunable lifetime multiplexing requires time-gated decoding devices. The complexity of material structures and special identification methods limit the commercial application of these anti-counterfeiting materials. Therefore, it is necessary to develop an anti-counterfeiting material with a simple identification method and high security level.

Thus, based on the above technical problems, there is an urgent need to provide an anti-counterfeiting material with a simple identification method and high security level.

### SUMMARY

To address the above technical problems, the disclosure provides a single-mode excitation color-changing luminescent upconversion material and a preparation method thereof. The disclosure adopts an anion doping strategy and uses a solid-state reaction method to prepare AₓMOCl_{y-1}:Yb/Ln upconversion materials. Under single-mode near-infrared excitation, various color-changing upconversion luminescence pathways are achieved. This color-changing luminescent upconversion material not only offers a simple and convenient identification method but also provides a high level of security anti-counterfeiting, with potential applications in the anti-counterfeiting field.

The first objective of the disclosure is to provide a single-mode excitation color-changing luminescent upconversion material. The molecular formula of the single-mode excitation color-changing luminescent upconversion material is AₓMOCl_{y-1}:Yb/Ln;
where A is at least one of Lithium(I) ion (Li⁺), Sodium(I) ion (Na⁺), Potassium(I) ion (K⁺), or Cesium(I) ion (Cs⁺);
M is at least one of Lanthanum(III) ion (La³⁺), Yttrium(III) ion (Y³⁺), Gadolinium(III) ion (Gd³⁺), or Lutetium(III) ion (Lu³⁺);
Ln is at least one of Erbium(III) ion (Er³⁺), Holmium(III) ion (Ho³⁺), or Thulium(III) ion (Tm³⁺); and

$$1 \leq x \leq 4 , and 4 \leq y \leq 7 .$$

In an embodiment of the present disclosure, in the formula AₓMOCl_{y-1}:Yb/Ln, Ytterbium(III) ion (Yb³⁺) acts as the sensitizer occupying M sites, with a doping amount of 1 percent (%)-30%.

In an embodiment of the present disclosure, in the formula AₓMOCl_{y-1}:Yb/Ln, Lanthanide(III) ion (Ln³⁺) acts as the activator occupying M sites, with a doping amount of 0.1%-5%.

In an embodiment of the present disclosure, in the formula AₓMOCl_{y-1}:Yb/Ln, oxygen ion (O²⁻) acts as the doped anion occupying Chlorine (Cl) sites.

In an embodiment of the present disclosure, the excitation wavelength of the single-mode excitation color-changing luminescent upconversion material is 950 nanometers (nm)-1100 nm.

In an embodiment of the present disclosure, the emission wavelength of the single-mode excitation color-changing luminescent upconversion material is 400 nm-800 nm.

In an embodiment, the color changes of the single-mode excitation color-changing luminescent upconversion material include but are not limited to red to green, green to cyan, and green to blue.

The second objective of the disclosure is to provide a preparation method for the single-mode excitation color-changing luminescent upconversion material, including the following steps: mixing chlorides of A, chlorides of M, a sensitizer, and an activator using a solid-state reaction method to obtain the single-mode excitation color-changing luminescent upconversion material.

In an embodiment of the present disclosure, the chloride of A is selected from one or more of Lithium chloride (LiCl), Sodium chloride (NaCl), Potassium chloride (KCl), and Cesium chloride (CsCl);
the chlorides of M are selected from one or more of Lanthanum trichloride (LaCl₃), Yttrium trichloride (YCl₃), Gadolinium trichloride (GdCl₃), and Lutetium trichloride (LuCl₃);
the sensitizer is Ytterbium trichloride (YbCl₃); and
the activator is selected from one or more of Erbium trichloride (ErCl₃), Holmium trichloride (HoCl₃), and Thulium trichloride (TmCl₃).

In an embodiment of the present disclosure, the solid-state reaction involves a heat treatment temperature of 100 degrees Celsius (° C.)−500° C. and a duration of 2-48 hours (h).

In an embodiment of the present disclosure, the specific preparation method is as follows:

mixing chlorides of A, chlorides of M, a sensitizer, and an activator in a ratio of a formula AₓMOCl_{y-1}:Yb/Ln, grinding uniformly, and performing the solid-state reaction in a muffle furnace, tube furnace, or oven to obtain the single-mode excitation color-changing luminescent upconversion material.

Compared with the prior art, the disclosure has the following advantages.

Doping with O²⁻ anions, where oxygen ion (O²⁻) occupies Cl sites, reduces the crystal field symmetry; the low-symmetry crystal field facilitates Stark splitting of the 4f energy levels of small-radius rare-earth ions under laser-induced thermal effects, altering the upconversion luminescence dynamics; consequently, the upconversion mechanism shifts from energy transfer upconversion to excited-state absorption, enabling thermally responsive color-changing upconversion luminescence.

A solid-state reaction method is adopted in the preparation process, ensuring stable optical performance.

Single-mode excitation triggers color-changing luminescence, offering a simple and convenient identification method.

Diverse color-changing luminescence pathways enhance anti-counterfeiting technology.

### BRIEF DESCRIPTION OF THE DRAWINGS

In order to make the content of the present disclosure more clearly understood, the following further detailed description of the present disclosure is provided based on the specific embodiments of the present disclosure and in combination with the attached drawings.

FIG. 1 shows the X-ray Diffraction (XRD) pattern of Cs₂GdOCl₄:Yb/Er in Embodiment 1 of the present disclosure.

FIG. 2 shows the upconversion emission spectra of the color-changing luminescent upconversion material Cs₂GdOCl₄:Yb/Er under 975 nanometers (nm) excitation at different times in Embodiment 1.

FIG. 3 shows the integrated intensity diagram of the emission spectra of the color-changing luminescent upconversion material Cs₂GdOCl₄:Yb/Er at 525 nm (Green) and 660 nm (Red) in Embodiment 1.

FIG. 4 shows the color-changing luminescence photos of the emission spectra of the color-changing luminescent upconversion material Cs₂GdOCH₄:Yb/Er powder within 4 seconds(s) in Embodiment 1.

FIG. 5 shows the XRD pattern of CsGdOCl₃:Yb/Ho in Embodiment 2 of the present disclosure.

FIG. 6 shows the upconversion emission spectra of the color-changing luminescent upconversion material CsGdOCl₃:Yb/Ho under 975 nm excitation at different times in Embodiment 2.

FIG. 7 shows the integrated intensity diagram of the emission spectra of the color-changing luminescent upconversion material CsGdOCl₃:Yb/Ho at 475 nm (Blue), 530 nm (Green), 590 nm (Orange), and 650 nm (Red) in Embodiment 2.

FIG. 8 shows the color-changing luminescence photos of the emission spectra of the color-changing luminescent upconversion material CsGdOCl₃:Yb/Ho powder within 4 seconds(s) in Embodiment 2.

FIG. 9 shows the XRD pattern of K₃YOCl₅:Yb/Tm in Embodiment 3 of the present disclosure.

FIG. 10 shows the upconversion emission spectra of the color-changing luminescent upconversion material K₃YOCl₅:Yb/Tm under 975 nm excitation at different times in Embodiment 3.

FIG. 11 shows the color-changing luminescence photos of the emission spectra of the color-changing luminescent upconversion material K₃YOCl₅:Yb/Tm powder within 6 s in Embodiment 3.

### DETAILED DESCRIPTION OF THE EMBODIMENTS

The following describes the disclosure in detail with reference to specific embodiments and accompanying drawings to enable those skilled in the art to better understand and implement the disclosure. However, the embodiments provided are not intended to limit the disclosure.

### Embodiment 1 (Cs₂GdOCl₄:Yb/Er)

This embodiment provides a preparation method for a single-mode excitation color-changing luminescent upconversion material (Cs₂GdOCl₄:Yb/Er), the steps are as follows:

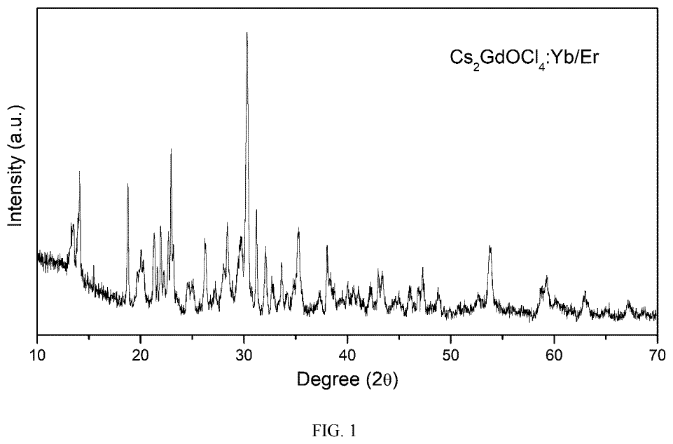

weighing 2 millimoles (mmol) of CsCl, 0.78 mmol of GdCl₃, 0.2 mmol of YbCl₃, and 0.02 mmol of ErCl₃, mixing uniformly in a mortar, and calcining the mixture in a tube furnace at 450 degrees Celsius (° C.) for 24 hours (h) to obtain Cs₂GdOCl₄:Yb/Er. Its XRD pattern is shown in FIG. 1.

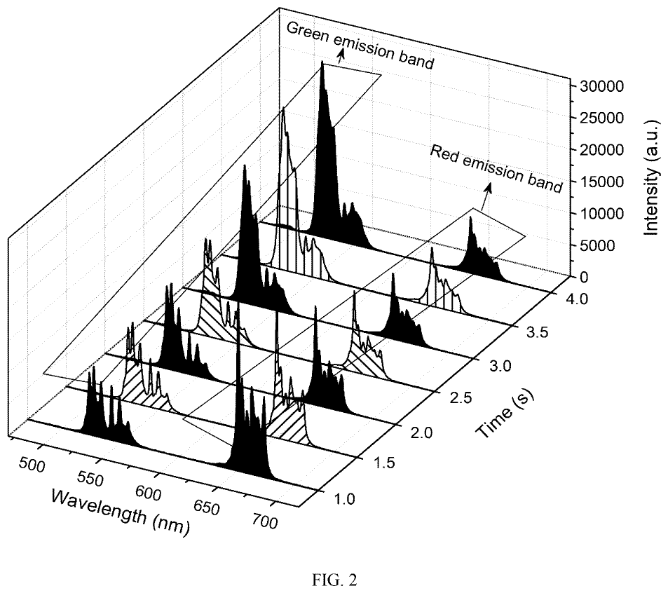

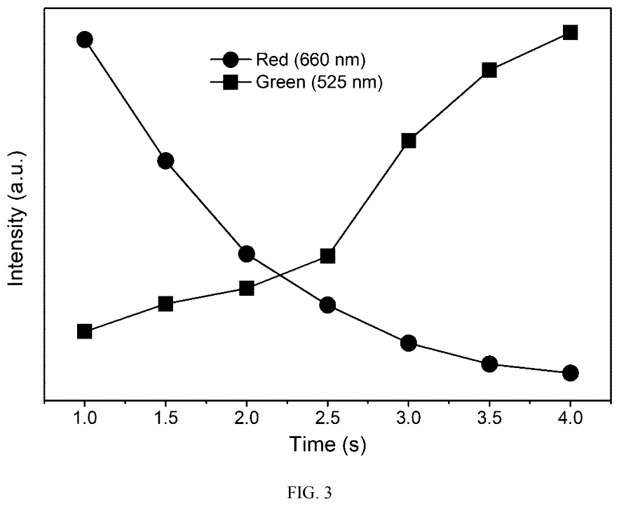

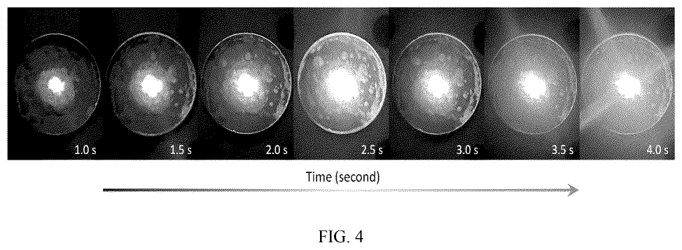

Under 975 nanometers (nm) excitation, the emission spectra of the obtained Cs₂GdOCH₄:Yb/Er are captured continuously. From the emission spectra and integrated intensity of the emission at different times (FIG. 2 and FIG. 3), it may be seen that the initial red emission band (−660 nm) intensity is higher than the green emission band (−525 nm), showing red emission. As excitation time increases, the red emission weakens while the green emission intensifies, eventually showing green emission. FIG. 4 demonstrates that Cs₂GdOCH₄:Yb/Er exhibits red-to-green color-changing luminescence within 4 seconds(s) under 975 nm excitation.

### Embodiment 2 (CsGdOCl₃:Yb/Ho)

This embodiment provides a preparation method for a single-mode excitation color-changing luminescent upconversion material (CsGdOCl₃:Yb/Ho), the steps are as follows:

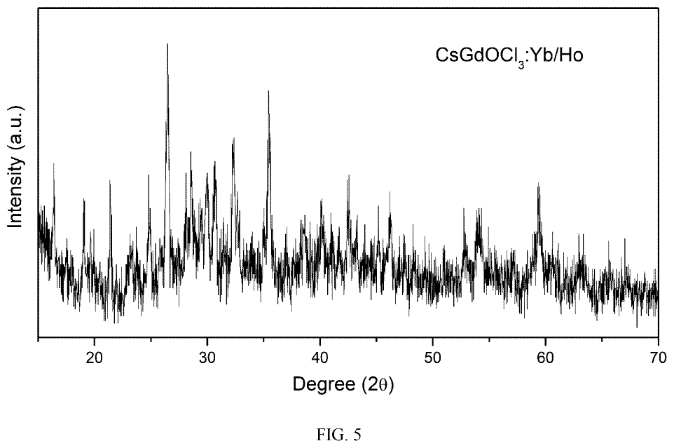

weighing 1 mmol of CsCl, 0.78 mmol of GdCl₃, 0.2 mmol of YbCl₃, and 0.02 mmol of HoCl₃, mixing uniformly in a mortar, and calcining the mixture in a muffle furnace at 300° C. for 2 h to obtain CsGdOCl₃:Yb/Ho. Its XRD pattern is shown in FIG. 5.

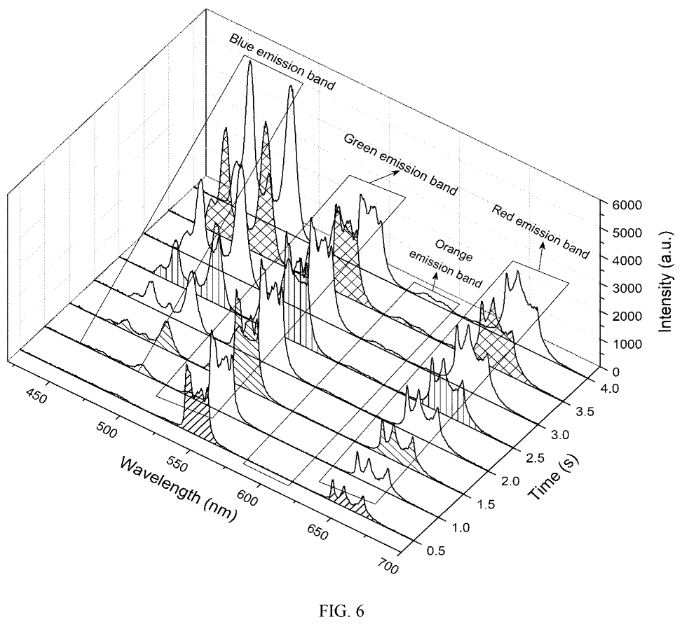

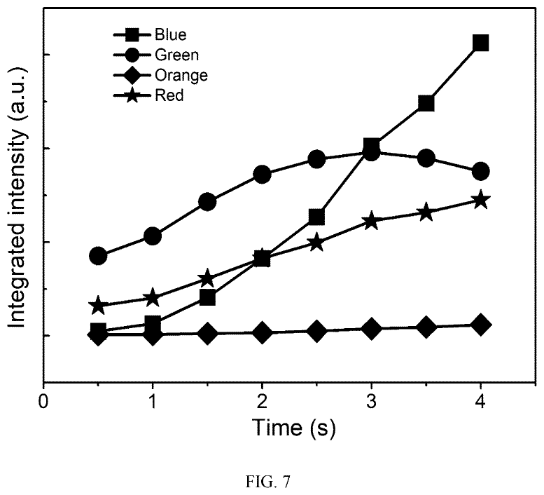

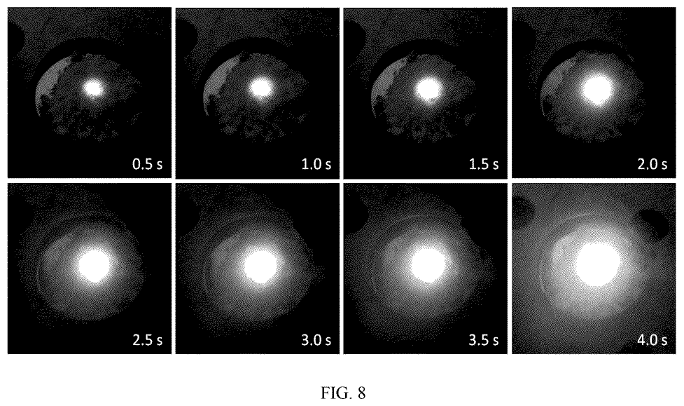

Under 975 nm excitation, the emission spectra of the obtained CsGdOCl₃:Yb/Ho are measured at different times. The emission bands in the spectra are integrated, and the results are shown in FIG. 6 and FIG. 7. It may be seen from FIG. 6 that at the initial stage of 975 nm excitation, the green emission intensity (−540 nm) of the sample is dominant, and its red emission intensity (−660 nm) is relatively weak, so the sample emits green light at the initial stage; with the prolongation of excitation time, the blue light emission intensity (−475 nm) of the sample gradually increases, and its intensity exceeds that of green light and red light in the later stage (shown in FIG. 7). As may be seen from FIG. 8, CsGdOCl₃:Yb/Ho exhibits green-to-cyan color-changing luminescence within 4 s under 975 nm excitation.

### Embodiment 3 (K₃YOCl₅:Yb/Tm)

This embodiment provides a preparation method for a single-mode excitation color-changing luminescent upconversion material (K₃YOCl₅:Yb/Tm), the steps are as follows:

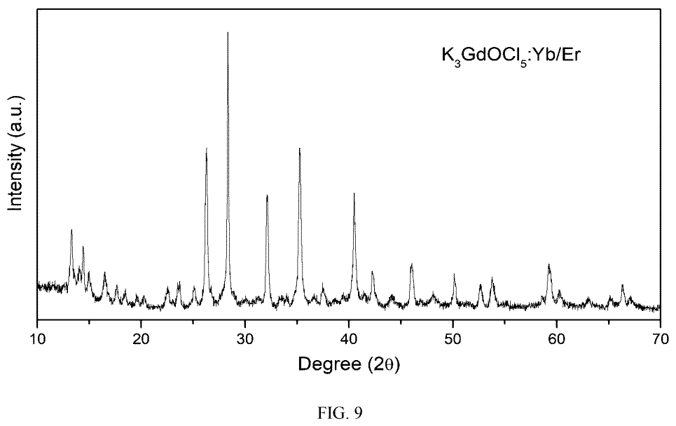

weighing 3 mmol of KCl, 0.79 mmol of YCl₃, 0.2 mmol of YbCl₃, and 0.01 mmol of TmCl3, mixing uniformly in a mortar, and heat-treating the mixture in an oven at 120° C. for 48 h to obtain K₃YOCl₅:Yb/Tm. Its XRD pattern is shown in FIG. 9.

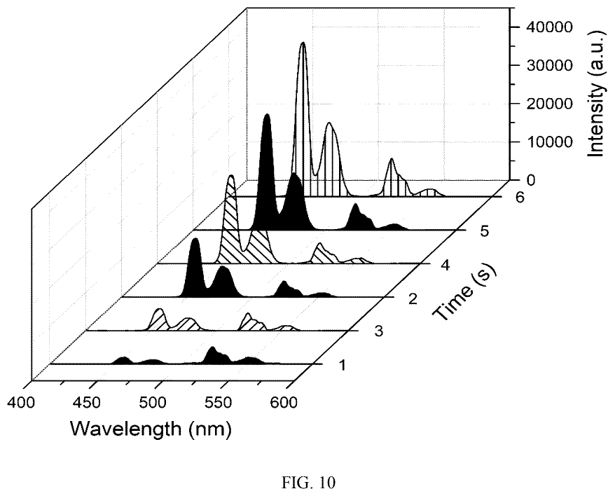

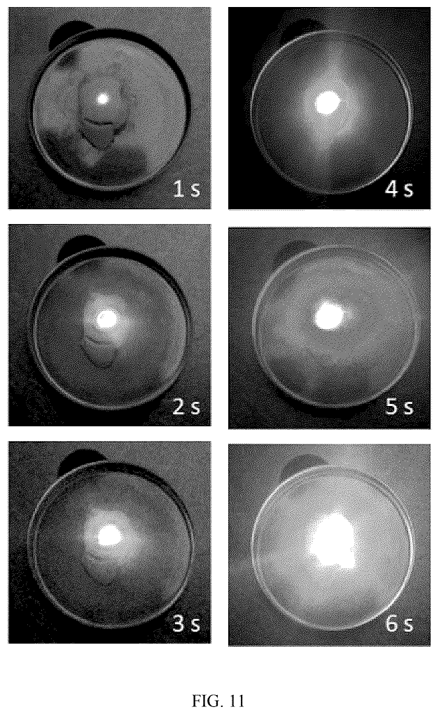

Under continuous 975 nm excitation, the emission spectra of the obtained K₃ YOCl₅:Yb/Tm are obtained at different times (FIG. 10). The emission spectrum initially shows a strong green emission peak at −525 nm and a weaker blue emission peak at −475 nm, resulting in green luminescence during the early excitation stage. As excitation time increases, while the green emission band intensifies, the blue emission band exhibits more significant enhancement, ultimately leading to blue-dominated luminescence in the later stage. The time-resolved luminescence photographs of the solid powder visually confirm this single-wavelength-excited color-changing (green to blue) upconversion phenomenon (FIG. 11).

It is evident that the above-described embodiments are merely illustrative embodiments provided for clarity, and are not intended to limit the scope of implementation. Those skilled in the art may make various modifications or adaptations based on the foregoing description without departing from the essence of the present disclosure. It is neither necessary nor possible to enumerate all possible implementations herein. Nevertheless, any obvious variations or modifications derived therefrom shall remain within the protective scope of the present disclosure.

1. A single-mode excitation color-changing luminescent upconversion material having a composition represented by a formula AₓMOCl_{y-1}:Yb and Ln, wherein the single-mode excitation color-changing luminescent upconversion material is prepared by a following method: mixing chlorides of A, chlorides of M, a sensitizer, and an activator in a ratio of the formula AₓMOCl_{y-1}:Yb and Ln, followed by a solid-state reaction to obtain the single-mode excitation color-changing luminescent upconversion material;
wherein A is at least one of Li⁺, Na⁺, K⁺, or Cs⁺;
M is at least one of La³⁺, Y³⁺, Gd³⁺, or Lu³⁺;
Ln is at least one of Er³⁺, Ho³⁺, or Tm³⁺;
Yb acts as a sensitizer and occupies M sites in an amount of 1-30 mol %, and Ln acts as an activator and occupies M sites in an amount of 0.1-5 mol %;
x=1, y=4; or x=2, y=5; or x=3, y=6; and
in the AₓMOCl_{y-1}:Yb and Ln, O²⁻ is a doped anion occupying Cl sites.

2. The single-mode excitation color-changing luminescent upconversion material according to claim 1, wherein an excitation wavelength of the single-mode excitation color-changing luminescent upconversion material is 950 nm-1100 nm; and
an emission wavelength of the single-mode excitation color-changing luminescent upconversion material is 400 nm-800 nm.

3. The single-mode excitation color-changing luminescent upconversion material according to claim 1, wherein color changes of the single-mode excitation color-changing luminescent upconversion material comprise red to green, green to cyan, or green to blue.

4. The single-mode excitation color-changing luminescent upconversion material according to claim 1, wherein the chlorides of A are selected from one or more of LiCl, NaCl, KCl, and CsCl;
the chlorides of M are selected from one or more of LaCl₃, YCl₃, GdCl₃, and LuCl₃;
the sensitizer is selected from YbCl₃; and
the activator is selected from one or more of ErCl₃, HoCl₃, and TmCl₃.

5. The single-mode excitation color-changing luminescent upconversion material according to claim 1, wherein a heat treatment temperature is 100° C.-500° C. and a heat treatment duration is 2-48 h in a solid-state reaction method.
